(19) United States
(12) Patent Application Publication
(10) Pub. No.: US 2005/0259631 A1
(43) Pub. Date: Nov. 24, 2005

(54) Route optiminzing in mobile ip providing location privacy

(76) Inventor: Jarno Rajahalme, Kirkkonummi (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/521,406

(22) PCT Filed: Jul. 19, 2002
(86) PCT No.: PCT/IB02/02842

§ 371 Date: Jan. 18, 2005

(51) Int. Cl. H04L 12/26

(52) U.S. Cl. 370/351; 370/238

(57) ABSTRACT

A routing method for routing data packets from a source terminal to a destination terminal via at least one communication network, said at least one communication network comprising at least one mobility agent entity for each of said terminals, the method comprising the steps of: establishing a route from the source via at least one first mobility agent, at least two consecutively arranged second mobility agents, to said destination, deciding that said route is to be optimized, rerouting said route from one of said at least one first mobility agents directly to one of the at least two consecutively arranged second mobility agents such that at least one intermediate mobility agent in said route is bypassed in the resulting rerouted route.

### FIELD OF THE INVENTION

The present invention relates to a routing method and system for routing data packets from a source terminal to a destination terminal via at least one communication network.

### BACKGROUND OF THE INVENTION

Recent developments in communication technology lead to communication networks operating based on the Internet Protocol (IP). In connection with mobile communication, Mobile IP is thus becoming more and more important. In communication networks, or network systems comprising plural individual networks interconnected with each other, data are forwarded in units of so-called data packets from a source terminal to a destination terminal. A mobile source terminal is referred to as mobile node MN, while a destination terminal (which may be a fixed or mobile terminal) is referred to as a correspondent node CN. Each of the interconnected networks comprises at least one mobility agent entity for each of said terminals. A mobility agent is any network entity implementing functionalities supporting mobility of the terminal within the network/network system while assuring that communication remains possible. For example, the expression “mobility agents” as used in the present text comprises
access routers (AR) enabling a terminal to access a respective network,
home agents (HA) as a node of the home network that causes the mobile node to be reachable at his home address even when the mobile node is not attached to its home network (note that non-home mobility agents take over the same tasks as home agents, while non-home mobility agents are not located in the node's home network, but rather in a visited network),
as well as edge routers (ER) (also known as gateways) providing interconnection between different networks constituting a network system.

As is generally known, Mobile IP includes a method of routing packets through a Home Agent (HA) to provide mobility transparency to the Correspondent Nodes (CN) and the Transport and Application layers in the Mobile Node itself. Routing packets through the HA results in long routes, especially when the MN is roaming in a network topologically/geographically distant from the home network. This is also known as the triangular routing problem.

Routing can be optimized through the usage of a dynamically assigned home agent from the visited network, or using other locally assigned addresses for communication with the Correspondent Nodes. This involves letting the correspondent node CN know the binding between the Home Address and the Care_of_Address. Binding in this connection denotes a triplet of numbers that contains the mobile node's (MN) home address (permanent address, e.g. IP address), its temporary address, i.e. CoA, and the registration lifetime (i.e. how long the mobility agents may use the binding).

GPRS networks as an example for mobile packet data networks manage mobility in conjunction with the link layer connectivity in the cellular access network. The currently defined methods assign an address to the MN from the address pool of either the local GGSN or a GGSN in the home network (GGSN=Gateway GPRS Support Node, GPRS=General Packet Radio Service).

It is to be noted that GPRS represents an example of a network only to which the present invention is applicable. The invention as subsequently described is, however, applicable to any routing of data packets from a source terminal to a destination terminal via at least one communication network, said at least one communication network comprising at least one mobility agent entity for each of said terminals. Also, the protocol used in such packet data networks is not limited to any specific protocol type. For example, Mobile IP version 4 (IPv4) or version 6 (IPv6), or GPRS specific protocols can be adopted.

An earlier patent application of Applicants which was filed in September 2001 describes a method of managing a Mobile IP Binding Cache outside of the Correspondent Nodes in their access network routers.

Thus, the problem resides in providing an IP routing between a Mobile Node MN and a Correspondent Node CN (often the correspondent node is itself a Mobile Node as well) where routing loops, or unnecessarily long routes in general are avoided, and at the same time the location privacy of both communicating nodes is protected. Also, it is essential to the system responsiveness and scalability that no connection state as such is required before the packets can be routed to the mobile node. Furthermore, signaling and other overhead over the air interface should be avoided.

The key in location privacy is that the address(es) used in the communication with the correspondent node reveal no information about the mobile's current location, or point of attachment in the packet network topology. Such information is included and/or can be deduced from the Care Of Address, for example.

There are at least two ways to provide addressing meeting this criterion:
The address be statically assigned and never change. In this way, no information about the current point of attachment is revealed.
The address may be dynamically assigned, but from an address pool that is not bound to any access network, or point of attachment to the packet data network.

The second option above has the added benefit that the mobile's use of the network will be harder to profile over time, if different addresses are used at different times by the same mobile device.

When the address conveys no information about the current point of attachment, the network must be able to map the address to an address in the access network where the mobile node is actually attached. The point in location privacy is that this mapping is hidden from the correspondent node.

Furthermore, to ensure the scalability of the network, the address used in the communication must be routable—packets sent with the address must reach a point in the network where the current location of the mobile node is known, so that the packet may be further forwarded to the mobile node in a timely fashion. The alternative, where a location look-up over the network is required before the packet sent to the mobile can be forwarded at all has the problem that the packets need to be queued at the origin access network while the location request is being served. This will cause initial delay, additional burstiness, and possible packet loss due to buffer overruns. Also, this will require location lookup for every small session of communication, while it would have been more preferable to take a hit in the routing efficiency (if any) for the benefit of less location signaling and state maintenance. Such a look-up concept involving so-called location privacy agents is disclosed in Applicants former patent application filed with the US PTO under Ser. No. 09/986,602 on Nov. 9, 2001.

The above means that a rendezvous point like the Mobile IP Home Agent (HA) is essential to any connectionless packet network providing mobility with location privacy. But routing everything via the home agent HA will cause unnecessary routing loops, especially when the mobile node MN is roaming in networks topologically far away from the home network, and is communicating with correspondent nodes outside of the home network. At an extreme this could for example mean to route the packets from U.S. to Finland and then back from Finland to U.S., if the mobile node's MN home agent HA is located in Finland, but the MN is roaming in the U.S. and communicating with an IP host in U.S.

Thus, from the foregoing it becomes clear that currently both GPRS and Mobile IP solutions suffer from the lack of optimized mobility and location privacy at the same time. They can provide for either optimal routing, or location privacy, but not both simultaneously.

### SUMMARY OF THE INVENTION

Consequently, it is an object of the present invention to provide an improved routing method and system for routing data packets from a source terminal to a destination terminal via at least one communication network, which method is free from the above mentioned drawbacks.

According to the present invention, the above object is for example achieved by a routing method for routing data packets from a source terminal to a destination terminal via at least one communication network, said at least one communication network comprising at least one mobility agent entity for each of said terminals, the method comprising the steps of: establishing a route from the source via at least one first mobility agent associated to said source, at least two consecutively arranged second mobility agents associated to said destination, to said destination, deciding that said route is to be optimized, and upon said decision, rerouting said route from one of said at least one first mobility agents directly to one of the at least two consecutively arranged second mobility agents such that at least one intermediate mobility agent in said route is bypassed in the resulting rerouted route.

In this connection, it is to be noted that rerouting can happen before a single packet has been transmitted via the (initially) established non-optimized route. That is, the route may still be in the process of being established or may have already been established. In each of the cases, an appropriate indication in a signaling such as resource reservation signaling may trigger rerouting even before the establishment of the (initial, non-optimized) route is actually completed.

According to favorable further developments
said decision is taken at one of said at least two second mobility agents associated to said destination,
said decision is based on an indication by the source or destination to optimize the route or to request for a specific quality of service for which route optimization is beneficial,
said decision is based on a service type of the traffic between the source and the destination,
said decision to optimize the route is taken in case the service type indicates a service imposing delay requirements,
said service type indicates real-time traffic,
said decision is based on an estimated benefit from route optimization between said source and said terminal, and in case said estimated benefit exceeds a predetermined threshold value, it is decided to reroute said route,
said rerouting comprises the steps of informing one of said at least one first mobility agents of a current care_of_address of the destination,
said informing comprises the steps of sending a message from one of said consecutively arranged second mobility agents to one of said first mobility agents including the current care_of_address of the destination,
said indication triggering the deciding for route optimization is included in a resource reservation signaling.

Furthermore, according to the present invention the above object is for example achieved by a routing system for routing data packets from a source terminal to a destination terminal via at least one communication network, said at least one communication network comprising at least one mobility agent entity for each of said terminals, the system comprising: route establishment means adapted for establishing a route from the source via at least one first mobility agent associated to said source, at least two consecutively arranged second mobility agents associated to said destination, to said destination, decision means adapted for deciding that said route is to be optimized, and, rerouting means, adapted to perform in response to said decision a rerouting of said route from one of said at least one first mobility agents directly to one of the at least two consecutively arranged second mobility agents such that at least one intermediate mobility agent in said route is bypassed in the resulting rerouted route.

According to favorable refinements of the present invention,
said decision means is located at one of said at least two second mobility agents associated to said destination,
said decision is based on an indication by the source or destination to optimize the route or to request for a specific quality of service for which route optimization is beneficial,
said decision is based on a service type of the traffic between the source and the destination,
said decision to optimize the route is taken in case the service type indicates a service imposing delay requirements,
said service type indicates real-time traffic,
said decision is based on an estimated benefit from route optimization between said source and said terminal, and in case said estimated benefit exceeds a predetermined threshold value, it is decided to reroute said route,
said rerouting means comprises informing means adapted for informing one of said at least one first mobility agents of a current care_of_address of the destination,
said informing means comprises sending means adapted to send a message from one of said consecutively arranged second mobility agents to one of said first mobility agents including the current care_of_address of the destination,
said indication triggering the decision means for deciding for route optimization is included in a resource reservation signaling.

By virtue of the present invention an advantageous routing method which simultaneously provides for optimal routing and for location privacy is realized, i.e. the location information of the destination is not leaked to the source or other non-trusted entities in the network

### BRIEF DESCRIPTION OF THE DRAWINGS

In the following, the present invention will be described in greater detail with reference to the accompanying drawings, in which

FIG. 1 shows a routing scenario in a packet network where the access router AR is a mobility agent, but where route optimization is not performed;

FIG. 2 shows a routing scenario in a packet data network according to the present invention;

FIG. 3 shows a routing scenario in a packet network system comprising two individual networks where the access router AR is a mobility agent, but where route optimization is not performed; and

FIG. 4 shows a routing scenario in a packet data network system according to the present invention.

### DETAILED DESCRIPTION OF THE EMBODIMENTS

The present invention will now be described in detail with reference to the drawings.

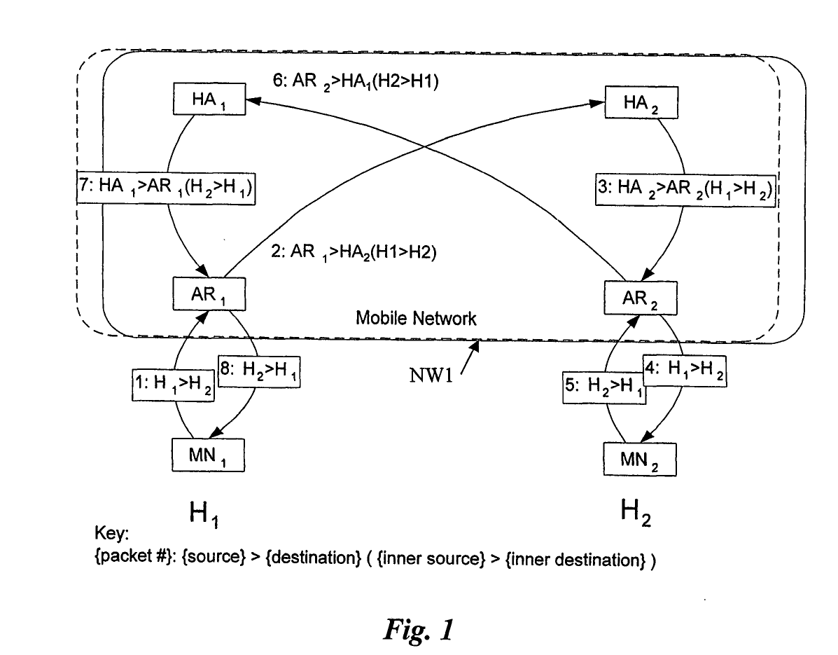

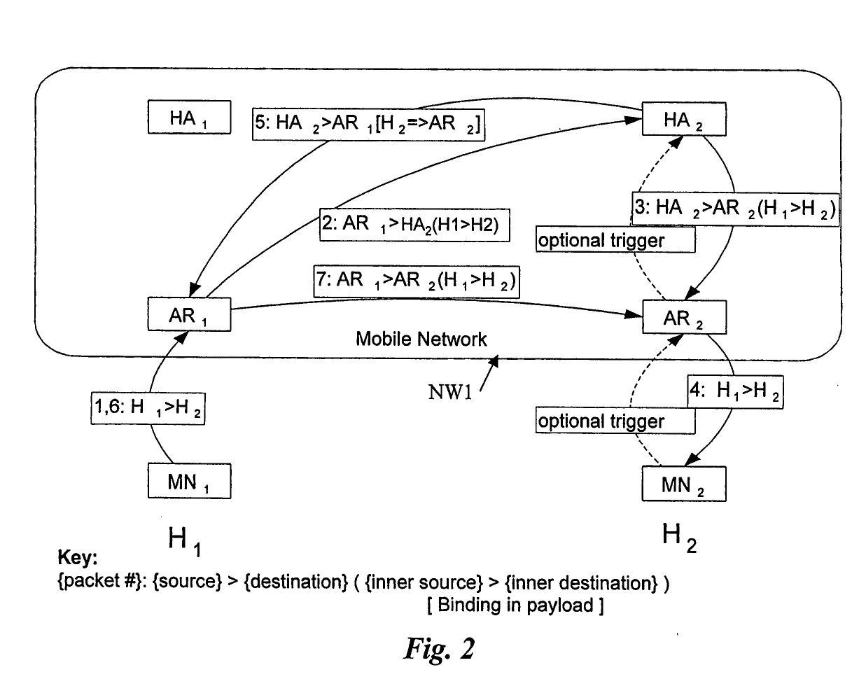

FIG. 1 shows a routing scenario in a packet network in order to enhance understanding of the invention as illustrated in FIG. 2 showing a routing scenario in a packet data network according to the present invention. Note that the same notation and reference signs are used throughout the Figures.

FIG. 1 illustrates an example in which only one single network, a so-called mobile network NW1 is present. This could be the case for a whole global network such as the Internet. The notation of the arrows exemplifies that a packet of the indicated number is transmitted, the number being also representative of a sequence of the transmission steps when routing a packet to be sent from a source to a destination. Following the number, the source of the packet is indicated, and “>” indicates that the packet is to be delivered/routed to the subsequently indicated destination. The expression in brackets following the destination represents an encapsulated addressing scheme (binding) which indicates the inner source and inner destination to which the respective packet is to be routed. This will become more apparent when referring to the following explanations.

Furthermore, MN1, MN2 denote mobile nodes acting as a source as well as a destination, respectively. The mobile nodes are identified and addressable by their home addresses H1, H2, respectively. Each of the mobile nodes access the network NW1 via an access router AR1, AR2, respectively, as a mobility agent for a respective one of said terminals. In addition, the network is provided with a respective Home agent HA1, HA2, respectively, for said mobile node MN1 and/or MN2. Even though it may not be excluded that HA1 and HA2 are locally close to each other or located at the same site, for the further explanations it is assumed that they are physically different entities. The same applies to the access routers as it is assumed that the source and destination terminals are geographically distant from each other so that they have to rely on the use of different access routers for accessing the network.

Now, a routing is described as illustrated in FIG. 1. Initially, mobile node MN1 with address H1 as the source addresses a packet in a first step 1 to the destination, i.e. mobile node MN2 with address H2, as denoted by 1:H1>H2. This reaches the access router AR1 responsible to provide network access to the mobile node MN1. The access router AR1, in a second step 2, forwards the received packet to the home agent HA2 in charge of supporting mobility for the destination mobile node MN2. The access router knows which home agent is in charge on the basis of the address H2 of the destination MN2; the packet is encapsulated and sent to the home agent HA2, as denoted by 2:AR1>HA2(H1>H2). Subsequently, step/packet 3, the home agent HA2 knows that for the addressed mobile node MN2 (address H2), access router AR2 is in charge and routes the packet to this access router, as denoted by 3:HA2>AR2(H1>H2). Finally, access router AR2 delivers the packet to the addressed destination MN2 with address H2. Note that dependent on the location of MN2 in the network, another access router, e.g. AR3 (not shown) could be contacted by the HA2. Thus, the access routers' addresses represent a care_of_address of the respective terminal associated thereto. Note that in steps 1 to 4 the same packet contents is forwarded/routed from MN1 to MN2 and only the packet header changes during routing due to the encapsulation.

Thus, after step 4, the initial packet to be routed from the source to the destination has been delivered from MN1 to MN2. Assuming that MN2 answers the message received from MN1, the packet flow is as denoted in FIG. 1, i.e. from MN2 to AR2 as denoted by 5:H2>H1, then from AR2 to HA1 as denoted by 6:AR2>H1(H2>H1), then from HA1 to AR1 as denoted by 7:HA1>AR1(H2>H1), and then from AR1 to MN1 as denoted by 8:H2>H1.

Apparently, there is established a route 1, 2, 3, 4 (from MN1 to MN2) and/or 5, 6, 7, 8 (from MN2 to MN1) from the respective source MN1/MN2 via a first mobility agent AR1/AR2 associated to said source, at least two consecutively arranged second mobility agents HA2, AR2/HA1, AR1 associated to said destination, to said destination MN2/MN1.

Every subsequent packet from MN1 to MN2 and vice versa will take the same routing through the network and will involve such a triangular routing of e.g. AR1->HA2->AR2. This may represent a rather long distance causing undesirable delays.

The present invention, when adhering to the example of FIG. 1 proposes a solution as illustrated in FIG. 2. Namely, once it is decided that said established route is to be optimized, and upon said decision, rerouting 5, 7 of said established route is performed from said first mobility agent AR1 directly to the last one AR2 of said consecutively arranged second mobility agents HA2, AR2 such that one or more HA2 intermediate second mobility agents in said established route are bypassed in the resulting rerouted route 6, 7, 4.

In this connection, it has to be noted again that for explanatory purposes the drawings are simplified. Thus, it should be kept in mind that basically it is not required for the invention that the *first* one does the rerouting to the *last* one. The only condition is be that the path is significantly shortened by the route optimization. For example, it may be that a 2^{nd} mobility agent reroutes the packets to a 5^{th} one, thus by-passing 3^{rd} and 4^{th} ones. More generally, there is established a route from the source via at least one first mobility agent associated to said source, at least two consecutively arranged second mobility agents associated to said destination, to said destination, decided that said route is to be optimized, and upon said decision, a rerouting of said route from one of said at least one first mobility agents directly to one of the at least two consecutively arranged second mobility agents is performed such that at least one intermediate mobility agent in said route is bypassed in the resulting rerouted route. Simultaneously, this is done so that the location information of the destination is not leaked to the source or other non-trusted entities in the network. This will be explained in more detail in the following. A comparison of the packet flow between FIGS. 1 and 2 reveals that steps 1 to 4 are identical. Hence a repeated description thereof is omitted. As an option, once a packet has reached MN2, a trigger input can be given from MN2 via AR2 to HA2, which trigger initiates rerouting the established route to a rerouted one. The home agent HA2 knows that packets to MN2 (address H2) have to be routed via AR2 to MN2. Thus, either upon receipt of the packet in step 2 or optionally upon receipt of the trigger, HA2 informs the access router AR1 in step 5 that packets with destination MN2 (address H2) are to be routed to AR2, as denoted by 5: HA2>AR1[H2=>AR2]. The expression in “[ ]” denotes the binding in payload.

Upon such rerouting a subsequent packet from MN1 at step 6 to AR1, AR1 will route the packet in step 7 directly to AR2, as denoted by 7:AR1>AR2(H1>H2), thereby bypassing HA2 for this and the subsequent packets. Stated in other words, the rerouting comprises the step “5” of informing said first mobility agent AR1 of a current care_of_address AR2 of the destination, wherein said informing comprises the steps of sending (5) a message from the first one HA2 of said consecutively arranged second mobility agents to said first, AR1, mobility agent including the current care_of_address of the destination.

Thus, routing distance is shortened, delivery of packets becomes faster and delay sensitive applications may benefit from such a routing. Simultaneously, the CoA of MN2, is not revealed to the source MN1. Rather, the CoA of MN2 is only informed to AR1 and kept within the network. Hence, location privacy of MN2 is maintained while routing is optimized. Of course, in case MN2 moves so that another AR becomes “responsible”, the binding will be updated.

As regards the decision for initiating route optimization, said decision is taken at one of said at least two second mobility agents associated to said destination, i.e. at HA2 or AR2. Since HA2 is the first of the mobility agents associated to MN2, it could be preferred to let HA2 decide on whether to perform route optimization or not.

The decision is for example based on an indication by the source to optimize the route. In this case, a packet sent from MN1 to MN2 includes, e.g. in its header, a corresponding indication such as a specific bit set to a predetermined value indicating that the routing is to be optimized.

Also, said decision can be based on a service type of the traffic between the source and the destination. In such a case, the service type (of the application to which the packet belongs) is indicated in the data packet or a signaling message. The mobility agent checks whether the service type of the packet matches a predetermined service type for which route optimization is to be performed, and if so, performs optimization as described above. Examples for such a service type may be a service type indicating a service imposing delay requirements, such as indicating real-time traffic.

Additionally or alternatively to the above, said decision can be based on an estimated distance between said source and said terminal, and in case said estimated distance exceeds a predetermined threshold distance value, it is decided by said mobility agent to reroute said established route, as described above. Stated in other words, the mobility agent (e.g. HA2 in the above example) evaluates/estimates the length of the packet route and dependent on the estimation decides to reroute packets. Thus, any packet may be rerouted dependent on the route length or only packets of a specific service type are rerouted dependent on the route length estimation.

Note that although FIG. 2 shows the route optimization for one direction only (MN1->MN2), the same principles apply for the other direction, i.e. MN2->MN1. However, this is not shown in FIG. 2 in order to keep the drawing simple. In such a case, HA1 would inform AR2 that AR2 has to route packets intended for MN1 from AR2 to AR1, bypassing HA1.

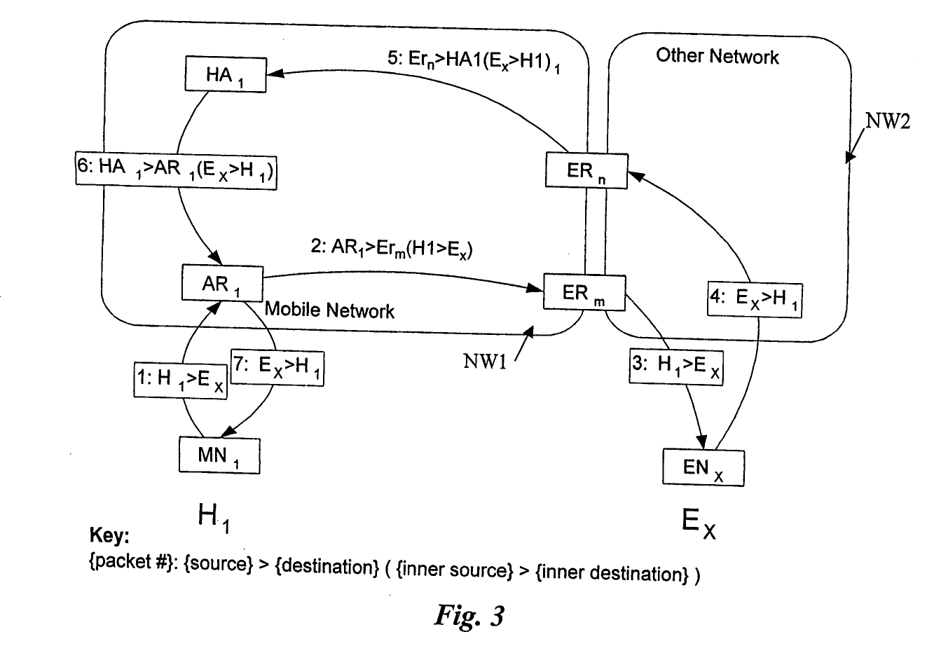

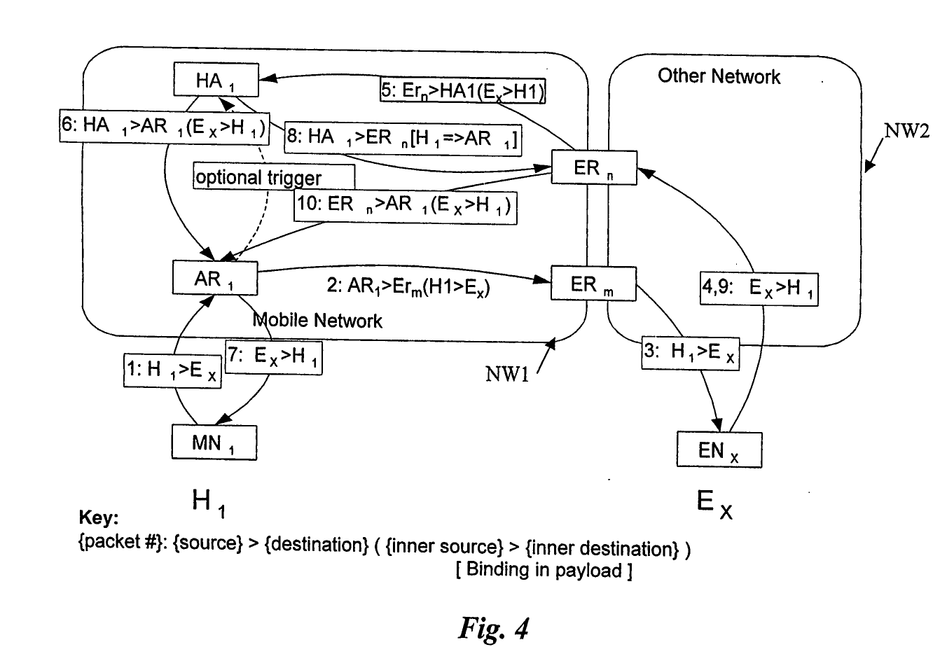

FIG. 3 shows a further routing scenario, but now in a packet network system comprising two individual networks NW1 and NW2, and FIG. 4 shows a routing scenario in such a packet data network system according to the present invention.

In FIG. 3 it is assumed that MN1 (address H1) as a source attached to network NW1 communicates with an external correspondent node ENₓ (address Eₓ) attached to another network NW2. The structure of network NW2 is transparent for the question of routing in connection with the present invention, as only the routing in network NW1 is focused here. Nevertheless, in network NW2 similar procedures can be established, however, these are omitted here from the description and illustration. As in FIGS. 1 and 2, associated to MN1 are an access router AR1 and a home agent HA1, both located in network NW1. The networks NW1 and NW2 are interconnected by means of so-called edge routers or gateways ERₙ and ERₘ. The edge routers ER can be identical, but can be topologically separated from each other. Here, the second case is assumed. Thus, agent ERm is fixedly assigned for routing traffic from NW1 to NW2, while ERn is assigned for the reverse traffic direction, i.e. NW2 to NW1.

The same notation regarding the signals/steps as in FIGS. 1 and 2 explained above also applies to FIGS. 3 and 4.

As shown in FIG. 3, MN1 sends a packet to ENx, as denoted by 1:H1>Ex, which initially reaches AR1. AR1 knows, e.g. based on the address Ex of ENx that edge router ERm is to be used for routing this packet, and routes the packet to ERm, as denoted by 2:AR1>ERm(H1>Ex). Then, transparent for the routing in NW1 the edge router ERm forward the packet to ENx, as denoted by 3:H1>Ex. When responding to the received packet, ENx forwards a packet to and/or via ERn as it knows that H1 in NW1 can be reached but via ERn, as denoted by 4:Ex>H1. ERn in turn, based on the address H1 of MN1 contacts the associated home agent HA1 in NW1 and forwards the packet to HA1, as denoted by 5:ERn>HA1(Ex>H1). The home agent knows that MN1 can be reached by its CoA, and forwards the packet accordingly, as denoted by 6:HA1>AR1. The access router AR1 in turn forwards the packet to the mobile node MN1, as denoted by 7:Ex>H1. It is to be noted here that from step 4 onwards the external node ENx acts a source and the mobile node MN1 acts as a destination. Thus routing from MN1 to ENx follows the route MN1->AR1->ERm->ENx, while in reverse direction it follows the route Enx->ERn->HA1->AR1->MN1.

Thus, within network NW1, packets routed to the mobile node MN1 (from the source in the external network NW2) are passing via the rather long route from ERn to HA1 to AR1 and then to MN1.

According to the present invention, when applied to this scenario, such drawback is prevented, as will become apparent from FIG. 4.

The present invention, when adhering to the example of FIG. 3, proposes a solution as illustrated in FIG. 4. Namely, once it is decided that said established route (to recapitulate: established route is represented by 4, 5, 6, 7) is to be optimized, and upon said decision, rerouting 8, 10 of said established route is performed from said first mobility agent ERn directly to the last one AR1 of said consecutively arranged second mobility agents HA1, AR1 such that one or more, HA1, intermediate second mobility agents in said established route are bypassed in the resulting rerouted route 9, 10, 7.

This will be explained in more detail in the following. A comparison of the packet flow between FIGS. 3 and 4 reveals that steps 1 to 7 are identical. Hence a repeated description thereof is omitted. As an option, once a packet has reached AR1, a trigger input can be given from AR1 to HA1, which trigger initiates rerouting the established route to a rerouted one. The home agent HA1 knows that packets to MN1 (address H1) have to be routed via AR1 to MN1. Thus, either upon receipt of the packet in step 5 or optionally upon receipt of the trigger, HA1 informs the edge router ERn in step 8 that packets with destination MN1 (address H1) are to be routed to AR1, as denoted by 8: HA1>ERn[H1=>AR1]. The expression in “[ ]” denotes the binding in payload.

Upon such rerouting a subsequent packet from ENx at step 9 to MN1, ERn will route the packet in step 10 directly to AR1, as denoted by 10:ERn>AR1(Ex>H1), thereby bypassing HA1 for this and the subsequent packets. Stated in other words, the rerouting comprises the step “8” of informing said first mobility agent ERn of a current care_of_address AR1 of the destination, wherein said informing comprises the steps of sending, 8, a message from the first one HA1 of said consecutively arranged second mobility agents to said first, ERn, mobility agent including the current care_of_address of the destination.

Thus, routing distance is shortened, delivery of packets becomes faster and delay sensitive applications may benefit from such a routing. Simultaneously, the CoA of MN1, i.e. AR1 is not revealed to the source ENx. Rather, the CoA of MN1 is only informed to ERn and kept within the network NW1. Hence, location privacy of MN1 is maintained while routing is optimized. Of course, in case MN1 moves so that another AR becomes “responsible”, the binding will be updated.

It is to be noted that the present invention can be implemented at nearly any time by taking the decision to reroute the established route. Therefore, the explanation referring to an initial “first” packet and subsequent “second” packet has been chosen as a mere example for enhancing understanding of the invention. As regards the decision to be taken, e.g. by HA1 in the case of FIG. 4, the same principles as explained before in connection with FIG. 2 apply.

Stated in other words, as mentioned above, it is very likely that most of the time routing via the HA will not cause any significant routing inefficiency, for example, when the subscriber is located close to his home, and the Home Agent situated topologically “close by” is used, no significant saving can be attained by route optimization. In general, it should therefore be decided on a case-by-case basis, whether route optimization will result in saving of delay, or network resources offsetting the cost of the route optimization related signaling and state maintenance. Taking such a decision can be based on criteria as explained above, while of course additional criteria may also be applied.

Taking the above into consideration it is the Home Agent itself, who has all the information needed to make the decision for the route optimization. Home Agent sees the address of the correspondent node CN, as well as the current care-of address CoA of the mobile node. The home agent can also profile and/or monitor the traffic between the two and decide if and when to initiate route optimization. Optionally, the AR or even the MN itself could be utilized in triggering the route optimization and thus reducing the burden on the Home Agent related to following the traffic patterns being forwarded. An example of this could be some resource reservation signal originating from the MN for requesting certain Quality of Service for a forthcoming traffic stream (e.g. real.time traffic). If low delay is requested, the related Home Agents could be asked to proactively arrange route optimization to decrease the end-to-end transmission delay.

Route optimization itself cannot be performed by the Mobile Node, or the Correspondent Node, since doing that would reveal the care_of_address of the other party to the other, and thus having no location privacy. Due to this the care-of addresses of the communicating entities need to be kept inside the network (Mobile Network). Mobility Agents at the edges of the network will take care of the route optimization, as signaled by the home agents.

The Access Routers providing network access for the Mobile Nodes will take care of the route optimization and are trusted not to reveal the care-of address of the correspondent node to the mobile node they are serving. Edge routers interfacing the other networks will terminate all mobility and route optimization related signaling to guard the location revealing information from leaking to non-trusted networks/entities.

In an ideal case, the whole global network (e.g. the Internet) would be mobile (the Mobile Internet) and utilizing this invention (FIG. 2). But in the meanwhile it is likely that mobility will emerge in individual networks, or coalition of networks with interest in mobility and protecting their customer's location privacy while providing best possible network service. An example of this situation with the present invention implemented is given in FIG. 4. The key to note here is that the Mobile Network is multi-homed, and has several edge routers interfacing to other networks. The same home addresses will be reachable through any of the edge routers. Note that the internal path length in the Mobile Network is not made visible to the external networks. The routing metrics will cause the shortest external path to be selected, so that an edge router closest to the correspondent node will be used to communicate with the mobile node. This is essential to the route optimization, since the edge router will in general remain in the path irrespective of the mobility optimizations done inside the mobile network.

The edge router will then tunnel the packet sent to the mobile node's home address to the MN's Home Agent. The tunneling method used is immaterial, but it is essential that the edge router's address will be carried or otherwise made known to the Home Agent. The Home Agent will further forward the packet to the access router serving the Mobile Node.

Various optimization schemes may be utilized to reduce the tunneling overhead within the network itself. It should be noted that this invention does not call for tunneling over the air interface (the interface between the MN and an Access Router).

In the reverse direction, the MN will send it's packets with it's Home Address as the source address. The AR will authorize the MN's use of the specific Home Address by communicating with the Home Agent either directly or via other mechanisms, such as AAA (e.g. via the Diameter protocol). The rest of the Mobile Network will trust on the access routers to block any unauthorized source addresses. The edge routers will enforce this by not forwarding packets out of the Mobile Network with source addresses out of the pool of Home Addresses valid in the Mobile Network.

The destination address used in the packets sent by an MN in the Mobile Network is the address of the correspondent node known to the MN. It can be a home address of another Mobile Node either in the same or different network, or a normal IP address of a fixed node in either the Mobile Network itself or an external network. Normal IP routing will cause an optimal (shortest) path to be taken to the destination address. If the destination address is a home address, it will reach the Home Agent of the destination, from where it is forwarded to the access router of the destination. If the destination's Home Agent will want to utilize route optimization, the HA will send a Binding Update towards the Access Router or an Edge Router who sent the packets to the HA. (this will initiate rerouting, as explained herein before.)

The initial network access registration is required to convey the MN's Home Address from the Home Network to the Access Router (AR). After this the AR will allow the MN to send packets with the Home Address as the source address in the IP packets. The AR's address can be used as the Care-of Address (CoA) for the MN, if IP-in-IP tunneling (or equivalent, such as GRE or GTP) is used for the transport of user's packets in the Mobile Network. Alternatively, the AR may allocate an unique CoA for the MN, allowing the AR to provide a one-to-one mapping between the CoA and the Home Address, enabling optimized encapsulation in most cases.

FIGS. 3 and 4 show a MN of the Mobile Network communicating with an external node ENx in another network. The likely possibility of asymmetric paths (different Edge Routers for the two directions) is also illustrated and explained before. Binding Update with the external network is shown below in FIG. 4. Essentially the Edge Routers maintain Binding Caches for the correspondent nodes in the other networks. No information about the MN's current location is sent to the other networks.

The address ownership management will be made easier by the fact that it is the HA owning the address that will be involved in the binding update process. Access and Edge Routers can be configured to accept binding updates from known Home Agents of the Mobile Network only. After the Binding exists the tunnel endpoints are responsible of refreshing the binding. The refreshing need not necessarily happen via the Home Agent.

Optionally, the access routers could initiate the binding updates without involving the home agents directly, but that requires the Home Agent to use the sending AR's address as the tunnel source address when forwarding the packet to the destination AR. This way the destination AR knows of the source AR, and will be able to decide whether to do an binding update or not.

Different versions of the Internet Protocol (IP) can be used for the service to the MNs and the transport inside the Mobile Network. For example, MN's could be provided with IPv6 service, even when the internal transport in the Mobile Network is utilizing IPv4.

The invention is applicable to the GPRS networks. Here the GGSNs are the Access Routers. Home Address of the MN could be fetched from the HLR/HSS. Subscriber's home operator would maintain Home Agents, where the current GGSN under which the Mobile is located is known. Edge routers would be managing Binding Caches for the mobiles of the GPRS network, enabling optimal routing. The tunneling method utilized could be the GPRS Tunneling Protocol (GTP).

Optimally, the GPRS network has Edge Routers situated on all the major geographical locations. This makes the mobile network span widest possible area, enabling route optimization. Packets from external networks would be routed to the GPRS network through the Edge Router closest to the traffic source, allowing the GPRS network to provide optimal routing without revealing any location information to the external network entities.

The established roaming agreements should be utilized to allow different GPRS networks to be combined into a federated network, inside of which the location information (current point of attachment) could be utilized to provide the best routes.

The present invention as outlined above proposes that resource reservation signaling should indicate that routing optimization should be performed. Also, for example, the Edge Routers maintain Binding Caches for the correspondent nodes in the other networks. No information about the MN's current location is sent to the other networks. The whole definition of the “Mobile Network” involves trust between the elements in the Mobile Network. For example, if an external node would try to use Edge Router's or Access Router's address as the source address, that would be spotted on one of the routers on the edge of the Mobile Network (ingress filtering). In addition, it is not unfeasible to have internal keying infrastructure covering the network elements of the mobile network. So the tunneling between ARs/ERs and the HAs would need to be covered by (possibly transitive) trust relationships between them. The invention proposes the HA to terminate the tunnel the ER (or AR) sends to it. The tunneling from the HA to the target MN would happen normally, assuming that the “AR” is provided to the HA as the care-of address.

Accordingly, as has been described herein above, the present invention concerns a routing method for routing data packets from a source terminal MN1, H1; Enx, Ex to a destination terminal MN2, H2; MN1, H1 via at least one communication network NW1; NW1, NW2, said at least one communication network comprising at least one mobility agent entity HA1, HA2, AR1, AR2, ERn, ERm for each of said terminals, the method comprising the steps of: establishing a route 1, 2, 3, 4; 4, 5, 6, 7 from the source MN1, H1; Ex, ENx via at least one first mobility agent AR1; ERn associated to said source, at least two consecutively arranged second mobility agents HA2, AR2; HA1, AR1 associated to said destination, to said destination MN2, H2; MN1, H1, deciding that said route is to be optimized, and upon said decision, rerouting said route from one of said at least one first mobility agents AR1; ERn directly to one of the at least two consecutively arranged second mobility agents AR2; AR1 such that at least one intermediate mobility agent HA2; HA1 in said route is bypassed in the resulting rerouted route. The present invention also concerns a corresponding system.

In detail, even though not expressly depicted in the drawings, the foregoing description of the present invention apparently also discloses a routing system for routing data packets from a source terminal (MN1, H1; Enx, Ex) to a destination terminal (MN2, H2; MN1, H1) via at least one communication network (NW1; NW1, NW2), said at least one communication network comprising at least one mobility agent entity (HA1, HA2, AR1, AR2, ERn, ERm)) for each of said terminals, the system comprising: route establishment means adapted for establishing a route (1, 2, 3, 4; 4, 5, 6, 7) from the source (MN1, H1; Ex, ENx) via at least one first mobility agent (AR1; ERn) associated to said source, at least two consecutively arranged second mobility agents (HA2, AR2; HA1, AR1) associated to said destination, to said destination (MN2, H2; MN1, H1), decision means adapted for deciding that said route is to be optimized, and, rerouting means, adapted to perform in response to said decision a rerouting of said route from one of said at least one first mobility agents (AR1; ERn) directly to one of the at least two consecutively arranged second mobility agents (AR2; AR1) such that at least one intermediate mobility agent (HA2; HA1) in said route is bypassed in the resulting rerouted route.

The decision means is located at one of said at least two second mobility agents (HA2, HA1) associated to said destination.

Said decision is based on an indication by the source or destination to optimize the route or to request for a specific quality of service for which route optimization is beneficial. Alternatively and/or additionally, said decision is based on a service type of the traffic between the source and the destination. For example, said decision to optimize the route is taken in case the service type indicates a service imposing delay requirements, e.g. said service type indicates real-time traffic.

Said decision is based on an estimated benefit from route optimization between said source and said terminal, and in case said estimated benefit exceeds a predetermined threshold value, it is decided to reroute said route. The benefit can be measured/expressed in a delay reduction (as compared to non-optimized routing, which in turn may correspond to a (shortened) distance between source and destination).

Said rerouting means comprises informing means adapted for informing one of said at least one first mobility agents of a current care_of_address of the destination, wherein said informing means comprises sending means adapted to send a message from one of said consecutively arranged second mobility agents to one of said first mobility agents including the current care_of_address of the destination.

Said indication triggering the decision means for deciding for route optimization is included in a resource reservation signaling.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A routing method for routing data packets from a source terminal (MN1, H1; Enx, Ex) to a destination terminal (MN2, H2; MN1, H1) via at least one communication network (NW1; NW1, NW2),
said at least one communication network comprising
at least one mobility agent entity (HA1, HA2, AR1, AR2, ERn, ERm)) for each of said terminals,
the method comprising the steps of:
establishing a route (1, 2, 3, 4; 4, 5, 6, 7) from the source (MN1, H1; Ex, ENx) via at least one first mobility agent (AR1; ERn) associated to said source,
at least two consecutively arranged second mobility agents (HA2, AR2; HA1, AR1) associated to said destination,
to said destination (MN2, H2; MN1, H1), deciding that said route is to be optimized, and upon said decision,
rerouting said route from one of said at least one first mobility agents (AR1; ERn) directly to one of the at least two consecutively arranged second mobility agents (AR2; AR1) such that at least one intermediate mobility agent (HA2; HA1) in said route is bypassed in the resulting rerouted route.

2. A method according to claim 1, wherein said decision is taken at one of said at least two second mobility agents (HA2, HA1) associated to said destination.

3. A method according to claim 1, wherein said decision is based on an indication by the source or destination to optimize the route or to request for a specific quality of service for which route optimization is beneficial.

4. A method according to claim 1, wherein said decision is based on a service type of the traffic between the source and the destination.

5. A method according to claim 4, wherein said decision to optimize the route is taken in case the service type indicates a service imposing delay requirements.

6. A method according to claim 4, wherein said service type indicates real-time traffic.

7. A method according to claim 1, wherein said decision is based on an estimated benefit from route optimization between said source and said terminal, and in case said estimated benefit exceeds a predetermined threshold value, it is decided to reroute said route.

8. A method according to claim 1, wherein said rerouting comprises the steps of informing one of said at least one first mobility agents of a current care_of_address of the destination.

9. A method according to claim 8, wherein said informing comprises the steps of sending a message from one of said consecutively arranged second mobility agents to one of said first mobility agents including the current care_of_address of the destination.

10. A method according to claim 3, wherein said indication triggering the deciding for route optimization is included in a resource reservation signaling.

11. A routing system for routing data packets from a source terminal (MN1, H1; Enx, Ex) to a destination terminal (MN2, H2; MN1, H1) via at least one communication network (NW1; NW1, NW2),
said at least one communication network comprising
at least one mobility agent entity (HA1, HA2, AR1, AR2, ERn, ERm)) for each of said terminals,
the system comprising:
route establishment means adapted for establishing a route (1, 2, 3, 4; 4, 5, 6, 7) from the source (MN1, H1; Ex, ENx)
via at least one first mobility agent (AR1; ERn) associated to said source,
at least two consecutively arranged second mobility agents (HA2, AR2; HA1, AR1) associated to said destination,
to said destination (MN2, H2; MN1, H1),
decision means adapted for deciding that said route is to be optimized, and,
rerouting means, adapted to perform in response to said decision a rerouting of said route from one of said at least one first mobility agents (AR1; ERn) directly to one of the at least two consecutively arranged second mobility agents (AR2; AR1) such that at least one intermediate mobility agent (HA2; HA1) in said route is bypassed in the resulting rerouted route.

12. A system according to claim 11, wherein said decision means is located at one of said at least two second mobility agents (HA2, HA1) associated to said destination.

13. A system according to claim 11, wherein said decision is based on an indication by the source or destination to optimize the route or to request for a specific quality of service for which route optimization is beneficial.

14. A system according to claim 11, wherein said decision is based on a service type of the traffic between the source and the destination.

15. A system according to claim 14, wherein said decision to optimize the route is taken in case the service type indicates a service imposing delay requirements.

16. A system according to claim 14, wherein said service type indicates real-time traffic.

17. A system according to claim 11, wherein said decision is based on an estimated benefit from route optimization between said source and said terminal, and in case said estimated benefit exceeds a predetermined threshold value, it is decided to reroute said route.

18. A system according to claim 11, wherein said rerouting means comprises informing means adapted for informing one of said at least one first mobility agents of a current care_of_address of the destination.

19. A system according to claim 18, wherein said informing means comprises sending means adapted to send a message from one of said consecutively arranged second mobility agents to one of said first mobility agents including the current care_of_address of the destination.

20. A system according to claim 13, wherein said indication triggering the decision means for deciding for route optimization is included in a resource reservation signaling.
